(19) United States
(12) Patent Application Publication
(10) Pub. No.: US 2008/0102903 A1
(43) Pub. Date: May 1, 2008

(54) EMERGENCY PLAN BATTERY ENERGY RESERVATION

(75) Inventors: Charles P. Schultz, North Miami Beach, FL (US); Daniel A. Baudino, Lake Worth, FL (US); Nona E. Gage, Sea Ranch Lakes, FL (US); Jose E. Korneluk, Lake Worth, FL (US)

Correspondence Address: CUENOT & FORSYTHE, L.L.C., 12230 FOREST HILL BLVD., SUITE 120, WELLINGTON, FL, 33414, US

(73) Assignee: Motorola, Inc., Schaumburg, IL (US)

(21) Appl. No.: 11/554,477

(22) Filed: Oct. 30, 2006

(51) Int. Cl. H04B 1/38

(52) U.S. Cl. 455/574

(57) ABSTRACT

A method (500) for reserving energy resources on a communication device (115, 120, 300). The method can include receiving an emergency indicator (135) associated with an emergency plan. Based on the emergency indicator, an amount of energy to reserve on a communication device can be selected. The selected amount of energy then can be reserved on the communication device. Receiving the emergency indicator can include receiving an indicator (140, 145) of an assigned role or task. Receiving the emergency indicator also can include receiving an indictor of the energy to be reserved. Selecting the amount of energy to reserve can include selecting an amount of energy associated with the role or task. In response to receiving the emergency indicator, an acknowledgement (150, 155) of whether an assignment of the role or task is accepted can be communicated.

### BACKGROUND OF THE INVENTION

1. Field of the Invention

The present invention generally relates to communication devices and, more particularly, to allocation of energy resources on the communication devices.

2. Background of the Invention

Mobile stations (e.g. mobile telephones, personal digital assistants, etc.) oftentimes prove to be invaluable tools during emergency situations and often help to save lives. For example, during a structure fire in which land-based telephone lines are damaged or destroyed, a mobile station can be used to contact emergency responders. Mobile stations also are commonly used to contact emergency responders after a serious traffic accident. If a child is injured while his parents are away from a land-based phone, calls can be placed to the parents' respective mobile stations to notify them of the child's circumstances. Still, there are a myriad of other circumstances in which mobile stations are used to establish otherwise unavailable communication links during emergency situations.

Unfortunately, mobile station users sometimes forget to charge their mobile stations on a regular basis, or become engaged in long communication sessions which deplete the energy stored in the mobile stations' batteries. In consequence, mobile stations sometimes are rendered inoperable due to lack of sufficient battery charge when a crisis occurs.

### SUMMARY OF THE INVENTION

The present invention relates to a method for reserving energy resources on a communication device. The method can include receiving an emergency indicator associated with an emergency plan. Based on the emergency indicator, an amount of energy to reserve on a communication device can be selected. The selected amount of energy then can be reserved on the communication device. Receiving the emergency indicator can include receiving an indicator of an assigned role or task. Receiving the emergency indicator also can include receiving an indictor of the energy to be reserved.

Selecting the amount of energy to reserve can include selecting an amount of energy associated with the role or task. In response to receiving the emergency indicator, an acknowledgement of whether an assignment of the role or task is accepted can be communicated. In addition, in response to the emergency plan being activated, access to the reserved energy can be permitted.

In response to the emergency plan being activated, a determination can be made whether there is sufficient energy available on the communication device to perform the role or task, and an indicator that indicates whether there is sufficient energy available on the communication device can be communicated. From a plurality of communication device components capable of implementing a particular function to perform the role or task, one of such components which will use a least amount of energy can be selected to implement the function.

In response to an amount of energy available on the communication device being near, approximately equal to or less than the reserved energy, a low energy level indicator can be presented on the communication device and/or at least one service on the communication device can be deactivated. Further, in response to performing an assigned role or task in accordance with the emergency plan, the energy reserve on the communication device can be updated to reflect at least one role or task presently remaining to be fulfilled.

The present invention also relates to a method for allocating energy resources on a plurality of communication devices. The method can include communicating an emergency indicator associated with an emergency plan to each of the plurality of communication devices. In response to an emergency being identified, an emergency plan activation indicator can be communicated to each of the communication devices. Communicating the emergency indicator can include communicating an assignment of a role or task to be performed. Further, communicating the emergency plan activation indicator can include communicating an indictor to each of the communication devices to perform its assigned role or task.

An acknowledgment of whether the respective communication devices have sufficient energy available to perform the assigned roles or tasks can be requested. Responsive to receiving an acknowledgement from a first of the communication devices that the first communication device lacks sufficient energy, the first communication device's role or task can be automatically re-assigned to a second communication device. An indicator can be sent to the second communication device requesting an acknowledgement of whether the second communication device has sufficient energy available to perform the role or task originally assigned to the first communication device.

The present invention also relates to a communication device. The communication device can include a communications adapter that receives an emergency indicator associated with an emergency plan. The communication device also can include a processor that, based on the emergency indicator, reserves an amount of energy on the communication device. The emergency indicator can include an indicator of an assigned role or task. Further, the amount of energy reserved on the communication device can include an amount of energy sufficient for performing the assigned role or task.

In response to the processor receiving the indicator, via the communications adapter the processor can communicate an acknowledgement of whether an assignment of the role or task is accepted. The communication device also can include a charge controller. In response to the emergency plan being activated, the processor can communicate with the charge controller to determine whether there is sufficient energy available on the communication device to perform the role or task and, via the communications adapter, communicate an indicator that indicates whether there is sufficient energy available on the communication device.

The communication device also can include a user interface. In response to an amount of energy available on the communication device being near, approximately equal to or less than the reserved energy, a low energy level indicator can be presented via the user interface.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 depicts the communications system of FIG. 1 in operation to activate an emergency plan;

FIG. 3 depicts a block diagram of a communication device that is useful for understanding the present invention;

FIG. 4 is a flowchart that is useful for understanding the present invention; and

FIG. 5 is another flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method for reserving energy resources on a communication device in accordance with an emergency plan. The communication device can receive an emergency indicator which indicates to the communication device to reserve a selected amount of energy for use in response to an emergency plan being activated. The communication device also can be assigned a role and/or task to be performed in response to an emergency. As used herein, a role defines activities which may need to be implemented by a user of the communication device in accordance with the emergency plan. As used herein, a “task” is an individual activity or any unit or collection of activities associated with the emergency plan that would result in depleting energy from a communication device while a user is fulfilling assigned responsibilities in accordance with the emergency plan.

In order to ensure that the communication device will have sufficient energy to perform any actions, fulfill requirements of any assigned roles, and/or perform any tasks that may be implemented in response to the emergency plan being activated, the communication device can reserve an amount of energy that is anticipated to be required for such purposes. If the remaining energy level of the communication device's battery is depleted to the reserve level during normal operation, an indicator can be presented on the communication device to alert a user that the communication device is functioning on reserve power. In addition, one or more services on the communication device can be terminated to conserve energy. If the communication device receives an indicator that the emergency plan is activated, the reserved energy can be made available to perform the assigned task.

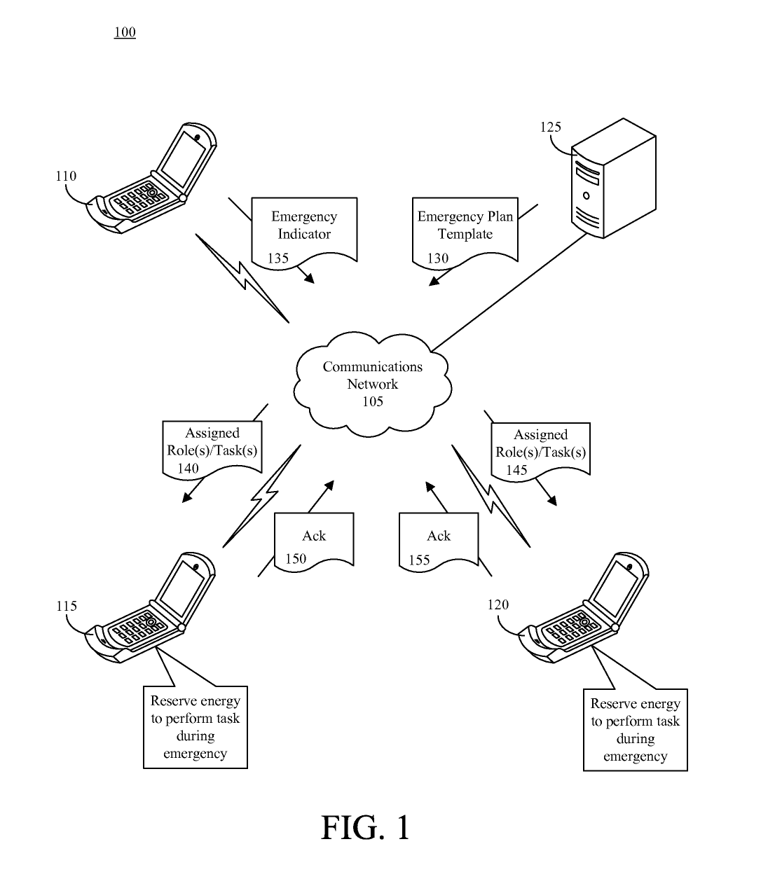

FIG. 1 depicts a communications system 100 that is useful for understanding the present invention. The communications system 100 can include a communications network 105, which can comprise, for example, the Internet, the World Wide Web, a wide area network (WAN), a local area network (LAN), a cellular communications network, a dispatch communications network, an interconnect communications network, a public switched telephone network (PSTN), and/or any other networks or systems over which communication signals can be propagated. In that regard, the communications network can include wired and/or wireless communication links.

The communications system 100 also can include a plurality of communication devices 110, 115, 120 communicatively linked to the communications network 105. The communication devices 110-120 can be mobile stations, such as personal digital assistants (PDAs), mobile telephones, mobile radios or mobile computers. The communication devices 110-120 also can be computers, network appliances, or any other electronic devices that may communicate via the communications network 105.

The communications system 100 may further include a server 125. The server 125 can be any processing device that is communicatively linked to the communications network 105 and which can process server requests from the mobile communication devices 110-120. For example, the server can be a network server, a web server, a mobile switching center, a base station controller, a base transceiver station, or any other suitable server.

In operation, an emergency plan can be created on the communication device 110, or selected using the communication device 110. For example, in one arrangement, an emergency plan template can be accessed from a datastore on the communication device 110. In another arrangement, an emergency plan template 130 can be received from the server 125, for instance in response to a user request. In another arrangement, the emergency plan can be created on the server 125 or the emergency plan template 130 can be completed on the server 125, for instance by establishing a communication session on the server 125. In yet another arrangement, a user can upload the emergency plan to the server 125. The emergency plan also can be generated in any other suitable manner.

A user of the communication device 110 can select communication devices 115, 120, or users associated with the communication devices 115, 120, to which/whom to communicate an emergency indicator 135. The emergency indicator 135 can be communicated by the communication device 110, or by the server 125. In an arrangement in which the emergency indicator 135 is generated by the communication device 110, a copy can be communicated to the server 125, in which case the server 125 can store a copy of the emergency indicator 135. In an arrangement in which the server 125 communicates the emergency indicator 135 to the communication devices 110-120, the server 125 can receive user inputs from any of the communication devices 110-120 or other communication devices to generate the emergency plan, and generate the emergency indicator 135.

The emergency indicator 135 can indicate to the communication devices to reserve energy for use in response to an emergency plan being activated. The emergency indicator 135 can indicate a type of emergency, for instance a hurricane, an injury, a lost pet, a theft or a fire. Accordingly, the energy reserved by the communication devices 115, 120 can correspond to an amount of energy which is anticipated to be required during the indicated emergency. In an arrangement in which a communication device 115 receives more than one emergency indicator 135, the communication device 115 can reserve an amount of energy that would be required for the emergency likely to require the most amount of energy.

In one arrangement, the emergency indicator 135 can include one or more assigned roles and/or tasks 140 for the communication device 115 and one or more assigned roles and/or tasks 145 for the communication device 120. Examples of assigned roles can include that of a guardian, a member (e.g. a member of a group), an associate, a pet sitter, an asset administrator, and the like. Examples of assigned tasks can include calling a doctor, contacting an insurance company, contacting a relative, contacting emergency responders, purchasing ice, filling a prescription, etc. It should be noted that the examples of emergency plans, roles and tasks identified herein are merely examples, and a myriad of other emergency plans, roles and tasks are anticipated to be used and therefore within the scope of the present invention.

In response to receiving the assigned role/task indicators 140, 145, the communication devices 115, 120 can accept or decline the assigned roles and/or tasks and communicate respective acknowledgements 150, 155 to the communication device 110 and/or the server 125. The acknowledgements 150, 155 can include indications of acceptance or declination.

In one aspect of the invention, in response to receiving the assigned role/task indicators 140, 145, the communication devices 115, 120 can present messages to respective users of the communication devices 115, 120 prompting such users to enter user inputs that indicate whether to accept or decline the assigned roles and/or tasks. The indicators communicated in each of the acknowledgements 150, 155 can correspond to a respective user input. In another arrangement, the decision whether to accept or decline the assigned roles/tasks can be performed automatically by the communication devices 115, 120 or the server 125 based on communication device and/or user settings. In addition, the communication devices 115, 120 can present reminders to respective users to signal the users to perform assigned roles and/or tasks.

In response to the acknowledgement 150 declining an assigned role and/or task, the communication device 110 and/or the server 125 can automatically select another communication device, or a user associated with another communication device, to which to assign the role and/or task. Alternatively, a user can be prompted to select another user or communication device.

In response to accepting an assigned role and/or task identified by the indicator 140, the communication device 115 can reserve an amount of energy required to perform the assigned role/task during an emergency. Similarly, in response to accepting an assigned role and/or task identified by the indicator 145, the communication device 120 can reserve an amount of energy required to perform the assigned role/task during an emergency. The indicators 140, 145 can indicate an amount of energy to be reserved. For example, the indicators can identify a role and/or task to be performed and an estimated duration to perform the role and/or task. Based on such indicators 140, 145, the communication devices 115, 120 can estimate amounts of battery charge that will be required to perform the roles and/or tasks for the required duration. The battery charge can be estimated in terms of milliamp-hours, percentage of total battery charge, or in any other suitable manner.

In one arrangement, the communication devices 115, 120 can perform such estimation by retrieving battery charge level indicators that correlate to the assigned roles/tasks from lookup tables or a database. Such lookup tables or database can be device specific. For example, if the communication devices 115, 120 are different models and the communication device 115 is more energy efficient than the communication device 120, the communication device 115 may require a lower amount of reserved energy in order to perform a particular task. The lookup tables or database can be contained on the communication devices 115, 120, on the server 125, or on another datastore communicatively linked to the communications network 105.

If during normal operation of a communication device, for instance the communication device 115, the energy available on the communication device drops to a level near, approximately equal to, or less than the reserved energy, a low energy level indicator can be presented by a user interface of the communication device 115. For example, a visual message can be presented on a display and/or an audible message can be presented via an output transducer. Further, one or more services on the communication device 115 can be deactivated. For example, non-essential services and/or services not relevant to performing an assigned role or task can be terminated. In another arrangement, one or more call sessions can be automatically terminated. Still, other power conservation steps can be implemented and the invention is not limited in this regard.

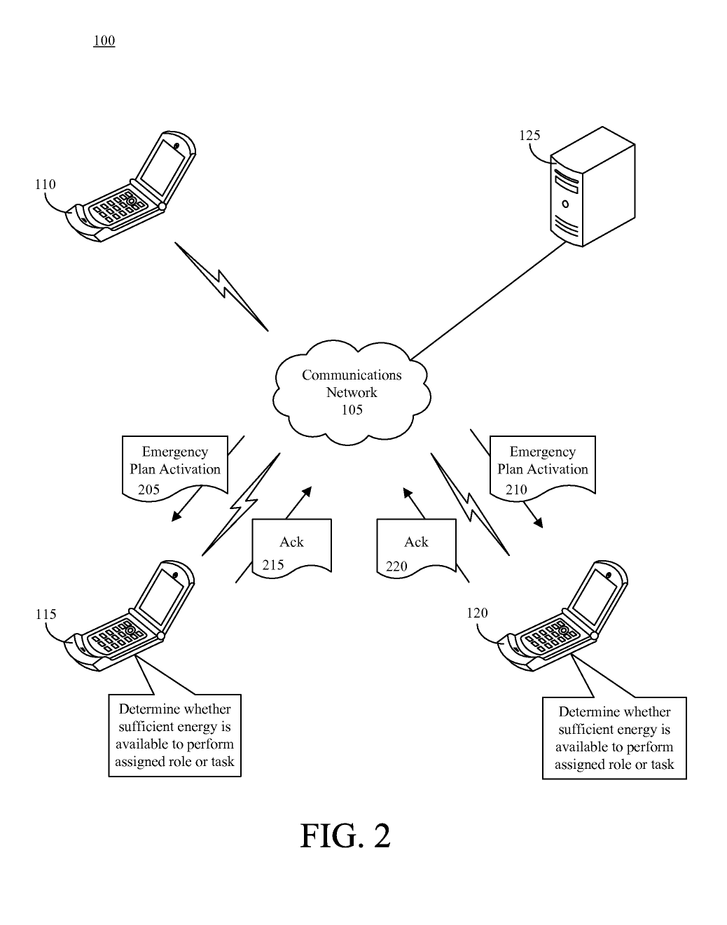

FIG. 2 depicts the communications system 100 of FIG. 1 in operation to activate an emergency plan. In response to an emergency or crisis, emergency plan activation indicators (hereinafter “activation indicators”) 205, 210 can be generated and communicated to the communication devices 115, 120, for example as communication messages. The activation indicators can indicate to each of the communication devices of a present emergency, and to perform their assigned roles or tasks, if any. The activation indicators 205, 210 also can prompt the communication devices 115, 120 to determine whether they have sufficient energy available to perform their assigned roles or tasks.

In one arrangement, the activation indicators 205, 210 can be generated by the communication device 110. However, the invention is not limited in this regard and the activation indicators 205, 210 can be generated by any other suitable communication device. For example, activation indicators 205, 210 can be generated by the communication device 115, the communication device 120 or the server 125. The activation indicators 205, 210 can be propagated to any communication devices 115, 120 identified in the emergency plan, communication devices 115, 120 associated with users identified in the emergency plan, the server 125, and/or any other communication devices identified by default or in user or device settings.

In response to receiving the activation indicators 205, 210, the communication devices 115, 120 can determine whether they have sufficient energy to perform their assigned roles and/or tasks and communicate an indicator of such determination in acknowledgements 215, 220 that are communicated to the mobile station 110, the server 125, or any other suitable communication device. If the communication devices 115, 120 do have sufficient energy available to perform their assigned roles and/or tasks, such roles/tasks can be performed as required.

In a further arrangement, non-essential services and/or services not relevant to performing the assigned roles or tasks can be terminated. Moreover, in a communication device which has multiple components capable of implementing a particular function to perform an assigned role, task, or any other processes, one of such components which will use the least amount of energy can be selected for performing the assigned role, task or other processes. For example, if the communication device 115 includes multiple processors, the processor that is most energy efficient can be selected for performing roles and/or tasks assigned to the communication device 115.

If the acknowledgement 215 indicates that the communication device 115 lacks sufficient available energy to perform its assigned role or task, the role and/or task assigned to the communication device 115 can be automatically re-assigned to another communication device. For example, an assigned role/task indicator can be communicated in a message to another communication device, and such assigned role/task indicator can prompt the other communication device to respond with an acknowledgement indicating whether the communication device has sufficient energy available to perform the role/task and whether the role/task assignment is accepted. Any of the communication devices 115, 120 having sufficient energy available to implement their assigned roles and/or tasks can implement such roles/tasks in response to the messages 205, 210.

After roles and/or tasks are performed by the communication device 115 in response to the emergency plan activation 205, the energy reserve on the communication device 115 can be updated to reflect only the plan, roles and/or tasks presently remaining to be fulfilled. For instance, if the level of energy initially reserved on the communication device 115 was based upon an assignment of five tasks, and only three tasks remain to be completed, the energy level that is reserved on the communication device 115 can be reduced to an amount of energy required to perform the three remaining tasks. Similarly, if an emergency plan is cancelled, the level of energy reserved on the communication device 115 can be recomputed to include only the energy necessary to perform functions in accordance with emergency plans, roles and/or tasks that are still assigned.

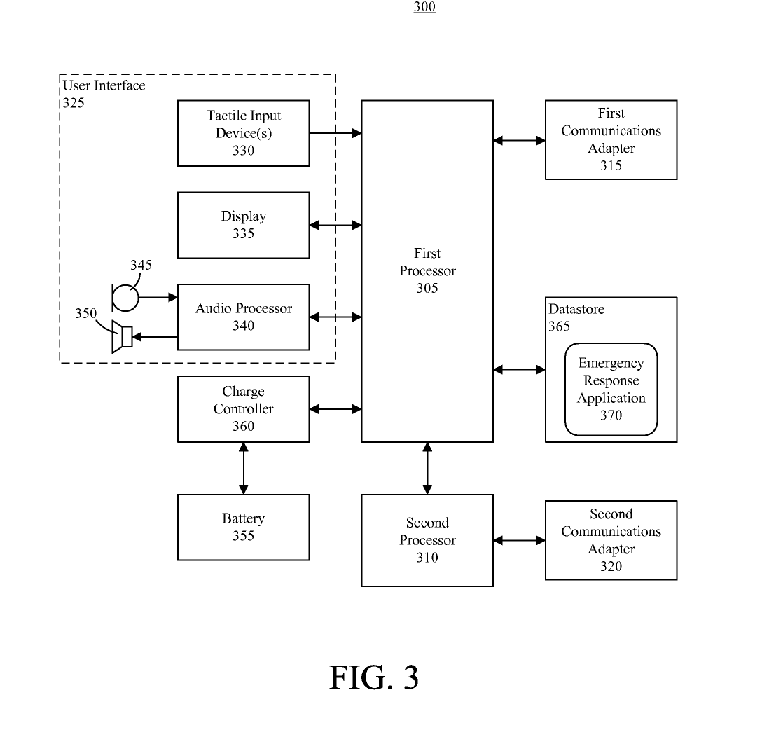

FIG. 3 depicts a block diagram of an example of a communication device 300 that is useful for understanding the present invention. Such communication device can be implemented as any of the communication devices previously described. The communication device can include a first processor 305. The first processor 305 can comprise, for example, a central processing unit (CPU), a digital signal processor (DSP), an application specific integrated circuit (ASIC), a programmable logic device (PLD), a plurality of discrete components that cooperate to process data, and/or any other suitable processing device. In one arrangement, the communication device 300 can include a second processor 310. The second processor 310 also can comprise a CPU, a DSP, an ASIC, a PLD, a plurality of discrete components that cooperate to process data, and/or any other suitable processing device. The first processor can be used for communicating in a first communication mode, for example a dispatch mode, and the second processor can be used for communicating in a second communication mode, for example an interconnect mode.

The communication device 300 also can include a first communications adapter 315 communicatively linked to the first processor 305. Optionally, a second communications adapter 320 also may be provided. The second communications adapter 320 can be communicatively linked to the second processor 310 or to the first processor 305. The first and/or the second communications adapters 315, 320 can be any data send/receive devices that are suitable for communicating via a communications network. For example, the first and/or second communications adapters 315, 320 can be transceivers that are configured to wirelessly communicate via a base transceiver station, a repeater, an access point, or any other suitable wireless network node. In another arrangement, the first and/or second communications adapters 315, 320 can be wired communication ports or network adapters configured to communicate via wired communications, for instance via a switch, a router, or any other suitable wired network node.

One or both of the communications adapters 315, 320 can send or receive the emergency plan task assignments, the emergency plan activation indicators, the assigned roles and/or tasks, emergency plan templates, acknowledgements, or communicate any other data described herein or data that is conventionally communicated by a communications adapter. Such communications can be at the behest of the first processor 305 and/or the second processor 310.

In one arrangement, the first communications adapter can communicate in accordance with a first communications protocol, for example a dispatch communications protocol, and the second communications adapter can communicate in accordance with a second communications protocol, for instance an interconnect communications protocol. A myriad of such protocols are presently available and within the scope of the present invention.

The communication device also can include a user interface 325 comprising one or more tactile input devices 330 and a display 335. The tactile input devices 330 can comprise one or more buttons, keys, soft keys, sensors, or any other devices suitable for receiving a tactile user input. The display 335 can be a liquid crystal display (LCD), a liquid crystal on silicon (LCOS) display, a cathode ray tube (CRT), a plasma display, or any other suitable display. In one arrangement, the display 335 can comprise a touch screen that can receive tactile and/or stylus inputs and communicate such inputs to the first processor 305 and/or the second processor 310.

The user interface 325 further can include an audio processor 340 connected to an input audio transducer 345 (e.g. microphone) and an output audio transducer 350 (e.g. loudspeaker). The audio processor 340 can be integrated with the processor 305 and/or the processor 310, or provided as a separate component that is communicatively linked to the processor 305 and/or the processor 310. The audio processor 340 can comprise a CPU, a DSP, an ASIC, a PLD, a plurality of discrete components that cooperate to process audio data, and/or any other suitable audio processing device.

The communication device 300 further can include a battery 355 and a battery charge controller 360. The battery charge controller 360 can monitor the effective charge level of the battery 355. For example, the battery charge controller 360 can measure the voltage of the battery 355, or monitor power drained from the battery 355 during operation of the communication device 300. For instance, the battery charge controller 360 can monitor an amount of power transferred from the battery 355. In another arrangement, the battery charge controller 360 can monitor an amount of transmit power used by the first communications adapter 315 and/or the second communications adapter 320 since the last battery re-charge, and subtract the transmit power used from a total available transmit power, which may be estimated based on a full battery charge. Nonetheless, the battery charge controller 360 can monitor the effective charge level of the battery 355 in any other suitable manner and the invention is not limited in this regard. In one arrangement, the battery charge controller can be integrated with the first processor 305 and/or the second processor 310.

In another arrangement, the battery 355 can include a datastore (not shown). The battery's datastore can include one or more storage devices, each of which can include a magnetic storage medium, an electronic storage medium, an optical storage medium, a magneto-optical storage medium, and/or any other storage medium suitable for storing digital information. In such an arrangement, the battery's datastore can retain information pertaining to an amount of energy to be reserved for an emergency plan, an assigned role and/or an assigned task. The battery's datastore also can retain information pertaining to a level of charge remaining on the battery. Accordingly, if the battery is removed from the communication device 300 and placed into another communication device, the battery reserve and charge level information can be made available to the other communication device.

The communication device 300 further can include a datastore 365. The datastore 365 also can include one or more storage devices, each of which can include a magnetic storage medium, an electronic storage medium, an optical storage medium, a magneto-optical storage medium, and/or any other storage medium suitable for storing digital information. In one arrangement, the datastore 365 can be integrated into the first processor 305 and/or the second processor 310.

An emergency response application 370 can be contained on the datastore 365. The first processor 305 and/or the second processor 310 can execute the emergency response application 370 to implement the processes and methods described herein. For example, the emergency response application 370 can be executed to create the emergency plan, enter data into an emergency plan template, communicate with the first communications adapter 315 and/or the second communications adapter 320 to receive send or emergency indicators, assign roles and/or tasks in accordance with an emergency response plan, accept or reject assigned roles or tasks, communicate with the battery charge controller 360 to reserve sufficient energy on the communication device to perform the assigned task, communicate with the battery charge controller 360 to determine whether sufficient energy is available to implement an assigned task, provide a low energy indicator when the available energy on the communication device 300 drops below a threshold value, and/or disable non-essential services and/or services not relevant to performing assigned tasks.

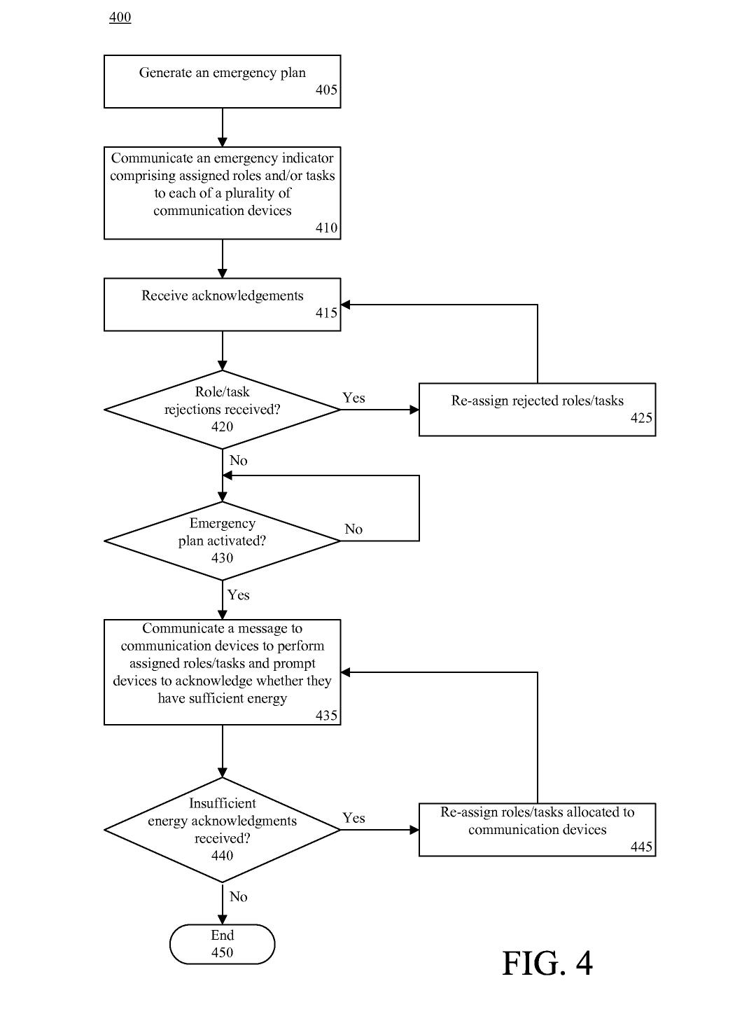

FIG. 4 is a flowchart presenting a method 400 that is useful for understanding the present invention. Beginning at step 405, an emergency plan can be generated on a communication device or a server. At step 410, an emergency indicator can be communicated to each of a plurality of communication devices. In one arrangement, the emergency indicator can comprise assigned roles and/or tasks to be performed in accordance with the emergency plan. At step 415, acknowledgements can be received from the communication devices accepting or rejecting the role and/or task assignments. Referring to decision box 420, if any role/task rejections are received, at step 425 the rejected roles or tasks can be re-assigned to other communication devices. In one arrangement, the roles/tasks can be automatically re-assigned. In another arrangement, a user can be prompted to select other communication devices or other users to which/whom to re-assign the rejected roles or tasks.

Referring to decision box 430, if the emergency plan is activated, at step 435 a message can be communicated to each of the communication devices to which roles/tasks are assigned. The message can instruct each of the communication devices to perform its assigned role or task, and to acknowledge whether it has sufficient energy to adequately perform such role or task. Referring to decision box 440, for any acknowledgements received indicating insufficient energy available to perform assigned roles/tasks, at step 445 such roles/tasks can be re-assigned to other communication devices and the process can return to step 435. In one arrangement, the roles/tasks can be automatically re-assigned. In another arrangement, a user can be prompted to select other communication devices or other users to which/whom to re-assign roles or tasks. Once the roles/tasks are assigned to communication devices having sufficient energy resources, the process can end at step 450.

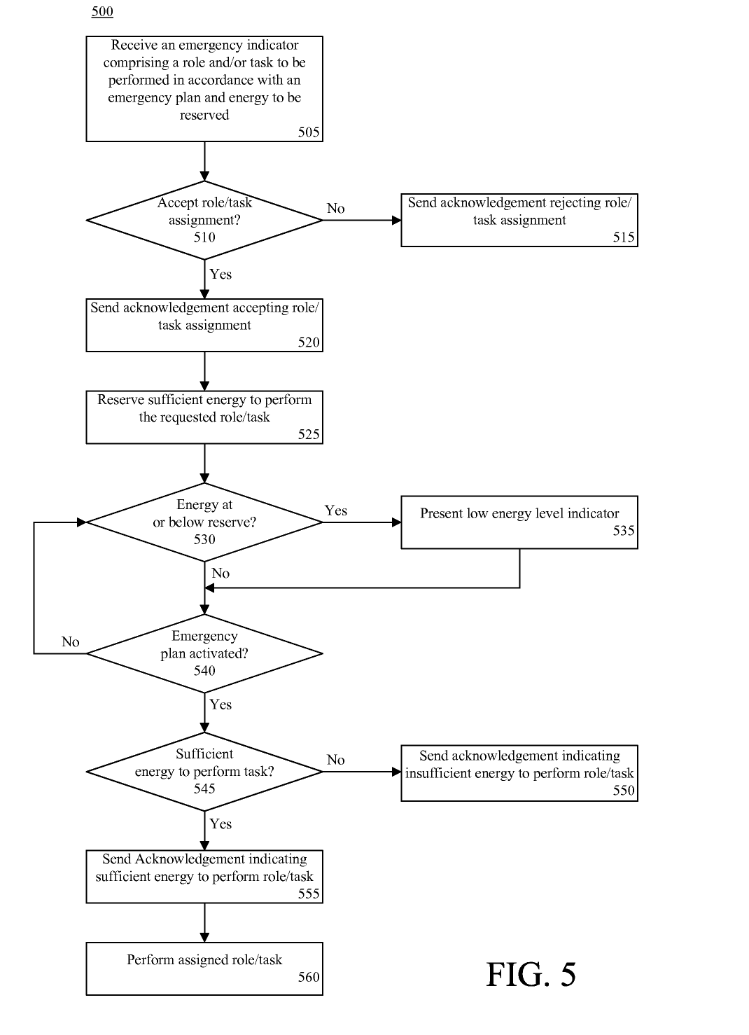

FIG. 5 is a flowchart presenting another method 500 that is useful for understanding the present invention. At step 505, on a communication device an emergency indicator can be received. The emergency indicator can indicate one or more roles and/or tasks to be performed in accordance with an emergency plan. The emergency indicator also can indicate energy to be reserved for performing the roles and/or tasks. Proceeding to decision box 510, if a role/task is not accepted, at step 515 an acknowledgement that rejects the role/task assignment can be sent.

If a role/task assignment is accepted, at step 520 an acknowledgement can be sent accepting the role/task assignment. Continuing to step 525, sufficient energy to perform the requested role and/or task can be reserved. Referring to decision box 530, if during normal operation the energy falls near, to or below the reserve level, at step 535 a low energy level indicator can be presented by the communication device.

Referring to decision box 540, if the emergency plan is activated, the process can continue to step 545 and a determination can be made whether the communication device has sufficient energy available to perform its assigned roles and/or tasks. If not, at step 550 an acknowledgment can be sent indicating that the communication device has insufficient energy available to perform the roles/tasks. If the communication device does have sufficient energy available to perform the roles and/or tasks, at step 555 the communication device can send an acknowledgment indicating that it has sufficient energy to perform the roles/tasks. Such acknowledgements can be sent to the communication device and/or server that activated the emergency plan, the communication device and/or server that assigned the roles/tasks, or any other suitable device. Continuing to step 560 the communication device can perform its assigned roles and/or tasks.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). As used herein, the terms “near,” “substantially” and “approximately” mean within a particular tolerance. Such tolerance can be within 30%, 20%, 10%, 5%, 1%, ½% and so on.

This invention can be embodied in other forms without departing from the spirit or essential attributes thereof. Accordingly, reference should be made to the following claims, rather than to the foregoing specification, as indicating the scope of the invention.

What is claimed is:

1. A method for reserving energy resources on a communication device, comprising:
receiving an emergency indicator associated with an emergency plan;
based on the emergency indicator, selecting an amount of energy to reserve on a communication device; and
reserving the selected amount of energy on the communication device.

2. The method of claim 1, wherein:
receiving the emergency indicator comprises receiving an indicator of an assigned role or task; and
selecting the amount of energy to reserve comprises selecting an amount of energy associated with the assigned role or task.

3. The method of claim 2, further comprising:
in response to receiving the emergency indicator, communicating an acknowledgement of whether the assigned role or task is accepted.

4. The method of claim 2, further comprising:
responsive to the emergency plan being activated, determining whether there is sufficient energy available on the communication device to perform the role or task; and
communicating an indicator that indicates whether there is sufficient energy available on the communication device.

5. The method of claim 1, wherein receiving the emergency indicator further comprises receiving an indicator of the energy to be reserved.

6. The method of claim 1, further comprising:
in response to an amount of energy available on the communication device being near, approximately equal to or less than the reserved energy, presenting a low energy level indicator on the communication device.

7. The method of claim 1, further comprising:
in response to an amount of energy remaining on the communication device being near, approximately equal to or less than the reserved energy, deactivating at least one service on the communication device.

8. The method of claim 1, further comprising:
in response to the emergency plan being activated, permitting access to the reserved energy.

9. The method of claim 1, wherein receiving the emergency indicator comprises receiving an indicator of an assigned role or task, further comprising:
from a plurality of communication device components capable of implementing a particular function to perform the assigned role or task, selecting to implement the function one of such components which will use a least amount of energy.

10. The method of claim 1, further comprising:
in response to performing an assigned role or task in accordance with the emergency plan, updating the energy reserve on the communication device to reflect at least one role or task presently remaining to be fulfilled.

11. A method for allocating energy resources on a plurality of communication devices, comprising:
communicating an emergency indicator associated with an emergency plan to each of the plurality of communication devices; and
in response to an emergency being identified, communicating an emergency plan activation indicator to each of the communication devices.

12. The method of claim 11, wherein:
communicating the emergency indicator comprises communicating an assignment of a role or task to be performed; and
communicating the emergency plan activation indicator comprises communicating an indicator to each of the communication devices to perform its assigned role or task.

13. The method of claim 12, further comprising:
requesting an acknowledgment of whether the respective communication devices have sufficient energy available to perform the assigned roles or tasks.

14. The method of claim 13, further comprising:
responsive to receiving an acknowledgement from a first of the communication devices that the first communication device lacks sufficient energy, automatically re-assigning the first communication device's role or task to a second communication device.

15. The method of claim 14, further comprising sending an indicator to the second communication device requesting an acknowledgement of whether the second communication device has sufficient energy available to perform the role or task originally assigned to the first communication device.

16. A communication device, comprising:
a communications adapter that receives an emergency indicator associated with an emergency plan; and
a processor that, based on the emergency indicator, reserves an amount of energy on the communication device.

17. The communication device of claim 16, wherein:
the emergency indicator comprises an indicator of an assigned role or task; and
the amount of energy reserved on the communication device comprises an amount of energy sufficient for performing the assigned role or task.

18. The communication device of claim 17, wherein, in response to the processor receiving the indicator, via the communications adapter the processor communicates an acknowledgement of whether an assignment of the role or task is accepted.

19. The communication device of claim 17, further comprising:
a charge controller;
wherein, in response to the emergency plan being activated, the processor communicates with the charge controller to determine whether there is sufficient energy available on the communication device to perform the task and, via the communications adapter, communicates an indicator that indicates whether there is sufficient energy available on the communication device.

20. The communication device of claim 16, further comprising:
a user interface;
wherein, in response to an amount of energy available on the communication device being near, approximately equal to or less than the reserved energy, a low energy level indicator is presented via the user interface.
